(19) United States
(12) Patent Application Publication
(10) Pub. No.: US 2010/0045117 A1
(43) Pub. Date: Feb. 25, 2010

(54) PROTECTION DEVICE FOR A POWER SOURCE AND POWER UNIT USING SAME

(75) Inventor: CHUAN-TSAI HOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/272,798

(22) Filed: Nov. 18, 2008

(30) Foreign Application Priority Data
Aug. 20, 2008 (CN) 200810304075.3

(51) Int. Cl. H01H 47/00

(52) U.S. Cl. 307/130

(57) ABSTRACT

A protection device for an output power source of an electronic device includes a compare unit, an invert unit and a switch unit. The compare unit is coupled with the output power source and receives an input voltage value and a predetermined voltage value from the output power source. The compare unit compares the input voltage value and the predetermined voltage value to generate a comparison signal. The invert unit is coupled with the compare unit and receives the comparison signal to generate an inverted signal. The switch unit is coupled with the output power source and the invert unit, and receives the inverted signal. If the input voltage value is higher than the predetermined voltage value, the switch unit turns on and outputs an output voltage, and if the input voltage value is lower than the predetermined voltage value, the switch unit turns off and has no output.

### BACKGROUND

1. Field

The invention relates to protection devices for a power source and, more particularly, to a protection device for an output power source of an electronic device.

2. Description of Related Art

Currently, an electronic device is designed to perform more and more functions, so that the components and circuit of the electronic device become more and more complicated. A protection for the circuit and the components of the electronic device is usually required. Power from an output power source of another electronic device to which the electronic device is connected is one of the reasons that the circuit and the components of the electronic device may be damaged. The power-supplying electronic device, for example, can be a computer and the electronic device, for example, can be a hard disk driver (HDD) mounted in the computer and electrically connecting with an output power source of the computer.

When the power-supplying electronic device outputs a power source, the components and circuit of the electronic device is powered so that the electronic device can perform its intended functions. When a component of the output power source of the power-supplying electronic device is broken or shorted, the output power source thereof outputs an improper electrical power to the components and circuit of the electronic device, which can cause irrecoverable damage to the components and circuit of the electronic device. Therefore, a protection device should be incorporated into the output power source of the power-supplying electronic device to prevent the output power source thereof from outputting an improper electrical power, which usually is a too high electrical power.

The protection device for the output power source available on the market normally consists of a plurality of components and a complicated circuit, which not only have a high cost but also occupy a large space.

What is needed, therefore, is a protection device for an output power source of an electronic device which is compact, has a low cost and a simple structure and can effectively prevent the power source from outputting an improper electrical power.

### BRIEF DESCRIPTION OF THE DRAWINGS

FIG. 1 is a block diagram of a protection device for an output power source of an electronic device in accordance with an embodiment.

FIG. 2 is a circuit diagram of the protection device of FIG. 1.

### DETAILED DESCRIPTION OF THE EMBODIMENTS

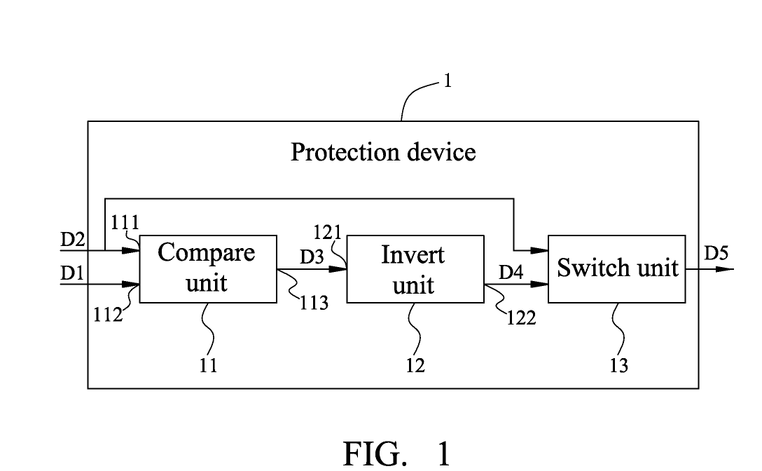

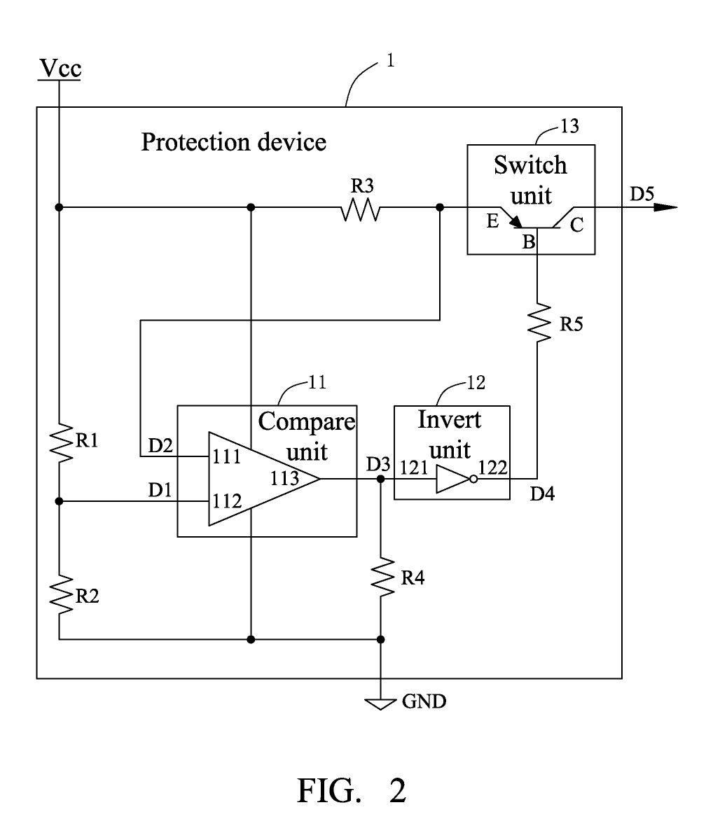

Referring to FIGS. 1 and 2, a protection device 1 for an output power source Vcc of an electronic device (not shown) according to an embodiment of the disclosure is shown. The output power source Vcc is for providing a power with a voltage V to another electronic device (not shown) electrically connected with the electronic device.

The protection device 1 includes a compare unit 11, an invert unit 12, a switch unit 13, a first resister R1, a second resister R2, a third resister R3, a fourth resister R4 and a fifth resister R5.

In this embodiment, the first resister R1 is connected between the output power source Vcc and the second resister R2. By the first and second resistors R1, R2, a predetermined voltage value D1 is obtained by the formula: D1=(V*R2)/(R1+R2). By the third resister R3 which is coupled with the output power source Vcc, an input voltage value D2 is obtained by the formula: D2=V−(R3*i), wherein i is a current which flows through the third resister R3. The third resister R3 is used to protect the switch unit 13 from a sudden rise of current applied thereto by the output power source Vcc. The value of the third resister R3 can be varied from 0Ω to a predetermined value, depending on the design parameters of the protection device 1. One end of the fourth resister R4 is connected in between the compare unit 11 and the invert unit 12, and the other end is connected with a ground GND and the second resister R2, and provides an initial input value to the invert unit 12. The fifth resister R5 is connected between the switch unit 13 and the invert unit 12.

The compare unit 11, which is an operational amplifier, has a first input end 111, a second input end 112 and an output end 113. The first input end 111 is coupled with the third resister R3 to receive the input voltage signal D2. The second input end 112 is connected in between the first resister R1 and the second resister R2 to receive the predetermined voltage value D1. The compare unit 11 compares the input voltage value D2 with the predetermined voltage value D1 and decides whether the former is higher or lower than the latter. The compare unit 11 generates a comparison signal D3 according to the comparison. The comparison signal D3 is outputted to the invert unit 12 via the output end 113 of the compare unit 11.

If the input voltage value D2 is higher than the predetermined voltage value D1, the compare unit 11 generates the comparison signal D3 which is high; if the input voltage value D2 is lower than the predetermined voltage value D1, the compare unit 11 generates the comparison signal D3 which is low.

In this embodiment, the invert unit 12 has an input end 121 and an output end 122, and the input end 121 is coupled with the output end 113 of the compare unit 11 and the fourth resister R4 to receive the comparison signal D3. The invert unit 12 inverts the comparison signal D3 into an inverted signal D4 and outputs the inverted signal D4 to the switch unit 13 through the output end 122 of the invert unit 12. The invert unit 12 is an inverter in accordance with the embodiment.

The switch unit 13 which is a PNP bipolar junction transistor (PNP BJT) has a base B, an emitter E and a collector C. The base B is coupled with the output end 122 of the invert unit 12 via the fifth resister R5 to receive the inverted signal D4, and the emitter E is coupled with the first input end 111 of the compare unit 11 and the third resister R3 to receive the input voltage value D2. The switch unit 13 transforms the input voltage value D2 into an output voltage D5, and controls the collector C to transmit or stop the output voltage D5 according to the value of the inverted signal D4 which is high or low. The output voltage D5 is for being electrically connected with and supplying the required power to another electronic device.

In operation, when the protection device 1 is coupled with the output power source Vcc, the third resister R3 divides the voltage V of the output power source Vcc to provide the input voltage value D2 to the first input end 111 of the compare unit 11, and the first resister R1 and the resister R2 divide the voltage V of the output power source Vcc to provide the predetermined voltage value D1 to the second input end 112 of the compare unit 11, simultaneously.

The compare unit 11 compares the input voltage value D2 and the predetermined voltage value D1. If the input voltage value D2 is higher than the predetermined voltage value D1, the compare unit 11 generates a comparison signal D3 which is high and outputted from the output end 113 to the invert unit 12. The invert unit 12 receives and inverts the comparison signal D3 into the inverted signal D4 which is low. The low inverted signal D4 is transmitted to the switch unit 13. The switch unit 13 turns on by the low inverted signal D4 and outputs the output voltage D5.

If the switch unit 13 has a short circuit, the input voltage value D2 becomes immediately zero volt. Therefore, the value of the comparison signal D3 is low, and the invert unit 12 inverts the comparison signal D3 into the inverted signal D4 which is high. The high inverted signal D4 is outputted to the switch unit 13. The switch unit 13 turns off by the high inverted signal D4 and has no output.

In this embodiment, the protection device 1 only consists of the compare unit 11, the invert unit 12 and the switch unit 13 and stops the output of the output voltage D5 when the switch unit 13 has a short circuit. In this way, along with the simple design of the protection device 1, the protection device 1 can reliably protect the components and circuitry of another electronic device which is electrically connected with the output power source Vcc through the protection device 1.

It is to be understood that the disclosure is intended to illustrate rather than limit the invention. Variations may be made to the embodiment of the disclosure without departing from the spirit of the invention as claimed.

What is claimed is:

1. A protection device for an output power source of an electronic device, comprising:
a compare unit configured for coupling with the output power source and receiving an input voltage value and a predetermined voltage value from the power source, the compare unit being capable of comparing the input voltage value and the predetermined voltage value to generate a comparison signal;
an invert unit coupling with the compare unit and receiving the comparison signal to generate an inverted signal; and
a switch unit configured for coupling with the output power source and connecting with the invert unit and receiving the inverted signal;
wherein if the input voltage value is higher than the predetermined voltage value, the switch unit turns on and outputs an output voltage, and if the input voltage value is lower than the predetermined voltage value, the switch unit turns off and has no output.

2. The protection device as claimed in claim 1, wherein the compare unit is an operational amplifier, the compare unit has a first input end, a second input end and an output end, the first input end is configured to be coupled with the output power source and receive the input voltage value, the second input end is configured to receive the predetermined voltage value, and the output end is coupled with the invert unit to output the comparison signal to the invert unit.

3. The protection device as claimed in claim 2, wherein a first resister is connected between the second input end of the compare unit and the output power source, a second resister is connected between the first resister and a ground, and a third resister is connected between the first input end of the compare unit and the output power source.

4. The protection device as claimed in claim 2, wherein a fourth resister is connected between the output end of the compare unit and a ground.

5. The protection device as claimed in claim 1, wherein the invert unit is an inverter, the invert unit has an input end and an output end, the input end is coupled with the compare unit and configured to receive the comparison signal, and the output end is coupled with the switch unit and configured to output the inverted signal to the switch unit.

6. The protection device as claimed in claim 5, wherein a fifth resister is connected between the output end of the invert unit and the switch unit.

7. The protection device as claimed in claim 1, wherein the switch unit is a PNP bipolar junction transistor (PNP BJT), the switch has a base, an emitter and a collector, the base is coupled with the invert unit and configured to receive the inverted signal, the emitter is coupled with the output power source and configured to receive the input voltage value, and the collector is configured to output the output signal.

8. A power unit with power protection function, comprising:
a power source to supply power;
a protection device, comprising:
a compare unit configured for coupling with the power source and receiving an input voltage value and a predetermined voltage value from the power source, the compare unit being capable of comparing the input voltage value and the predetermined voltage value to generate a comparison signal;
an invert unit coupling with the compare unit and receiving the comparison signal to generate an inverted signal; and
a switch unit configured for coupling with the power source and connecting with the invert unit and receiving the inverted signal;
wherein if the input voltage value is higher than the predetermined voltage value, the switch unit turns on and outputs an output voltage, and if the input voltage value is lower than the predetermined voltage value, the switch unit turns off and has no output.

9. The power unit as claimed in claim 8, wherein the compare unit is an operational amplifier, the compare unit has a first input end, a second input end and an output end, the first input end is configured to be coupled with the output power source and receive the input voltage value, the second input end is configured to receive the predetermined voltage value, and the output end is coupled with the invert unit to output the comparison signal to the invert unit.

10. The power unit as claimed in claim 9, wherein a first resister is connected between the second input end of the compare unit and the output power source, a second resister is connected between the first resister and a ground, and a third resister is connected between the first input end of the compare unit and the output power source.

11. The power unit as claimed in claim 9, wherein a fourth resister is connected between the output end of the compare unit and a ground.

12. The power unit as claimed in claim 8, wherein the invert unit is an inverter, the invert unit has an input end and an output end, the input end is coupled with the compare unit and configured to receive the comparison signal, and the output end is coupled with the switch unit and configured to output the inverted signal to the switch unit.

13. The power unit as claimed in claim 12, wherein a fifth resister is connected between the output end of the invert unit and the switch unit.

14. The power unit as claimed in claim 8, wherein the switch unit is a PNP bipolar junction transistor (PNP BJT), the switch has a base, an emitter and a collector, the base is coupled with the invert unit and configured to receive the inverted signal, the emitter is coupled with the output power source and configured to receive the input voltage value, and the collector is configured to output the output signal.
